(19) United States
(12) Patent Application Publication
(10) Pub. No.: US 2018/0100465 A1
(43) Pub. Date: Apr. 12, 2018

(54) Piston Assembly with Improved Lubrication Performance

(71) Applicant: Hyundai Motor Company, Seoul (KR)

(72) Inventors: Do Eon Kim, Bucheon-si (KR); Jin Tae Kim, Seoul (KR)

(21) Appl. No.: 15/390,181

(22) Filed: Dec. 23, 2016

(30) Foreign Application Priority Data
Oct. 11, 2016 (KR) 10-2016-0131160

(51) Int. Cl. F02F 3/22; F02F 3/00

(52) U.S. Cl. CPC F02F 3/22; F02F 3/0084; F02F 3/0015

(57) ABSTRACT

A piston assembly includes a steel piston body configured by joining an upper block and a lower block with each other, a plurality of ring grooves formed around an outer side surface of the steel piston body, a cooling gallery that is formed to be sealed by joining the upper block and the lower block with each other and that includes an inlet port and an outlet port so that oil flows into or out of the cooling gallery, and an oil hole formed to fluidically communicate the cooling gallery with a first oil groove disposed in the outer side surface of the steel piston body. When the steel piston body moves upwards, oil drawn into the cooling gallery is drawn into the first oil groove and thus is supplied to a skirt of the piston body.

### CROSS-REFERENCE TO RELATED APPLICATIONS

This application claims under 35 U.S.C. § 119(a) the benefit of priority to Korean Patent Application No. 10-2016-0131160, filed on Oct. 11, 2016, the entire contents of which are incorporated herein by reference.

### TECHNICAL FIELD

The present disclosure relates to a piston assembly with improved lubrication performance.

### BACKGROUND

Generally, for diesel engines, a sealed-type cooling gallery that receives cooling oil is formed in a piston body. Such a gallery is typically formed immediately inside a ring belt in a lower portion of a piston so as to cool an upper region of the piston during the operation of the piston.

That is, oil supplied into the gallery to cool an upper portion of the piston is drawn into the upper portion of the piston body and oil used to cool the upper portion of the piston is discharged out of the cooling gallery through a plurality of discharge holes or discharged into an internal space of the piston through a passage before being discharged to a crank case.

As such, the piston assembly including the cooling gallery according to the conventional art is configured such that oil is drawn into the cooling gallery so as to cool the upper portion of the piston, is moved downwards by its own weight after performing the cooling operation, and then is drawn into an oil gallery. That is, oil functions to perform only a function of cooling the piston head.

In such a typical piston assembly, a small end of a connecting rod that is coupled to the piston assembly to perform the operation of the piston body is configured such that the small end is directly coupled with a pin boss provided on the piston body. In this configuration, a lot of friction may occur. Hence, to enhance the performance of the piston, lubrication is required. Furthermore, additional lubrication may be required depending on movement of the piston body that makes contact with the inner wall of the cylinder.

FIG. 1 illustrates a steel piston assembly as a conventional art and shows the configuration in which oil is drawn into a sealed cooling gallery that is disposed in a piston head in order to cool the piston head.

However, even in the above-mentioned configuration including the sealed-type cooling gallery, there is no configuration in which oil used to cool the piston head provides lubrication of the piston body or lubrication between the piston and the small end of the connecting rod.

The above information disclosed in this Background section is only for enhancement of understanding of the background of the invention and therefore it may contain information that does not form the prior art that is already known in this country to a person of ordinary skill in the art.

Korean patent publication 10-2014-0034244 (KR10-2013-7033806) discloses subject matter that is related to subject matter disclosed herein.

### SUMMARY

The present disclosure relates to a piston assembly with improved lubrication performance. Particular embodiments relate to a piston for diesel engines which has a sealed-type cooling gallery for cooling a piston body and, more preferably, to a piston assembly with improved lubrication performance which is configured to improve the lubrication performance for movement of the piston using oil that functions to cool the piston body including the sealed-type cooling gallery.

Embodiments of the present invention provide a piston assembly with improved lubrication performance which is configured such that oil supplied into a cooling gallery of a steel piston can be additionally used to provide lubrication for a piston body and lubrication between a small end of a connecting rod and a piston pin boss.

Another object of the present invention is to enhance the lubrication performance of the piston assembly including the cooling gallery and provide enhanced operation performance of the piston body.

In order to accomplish the above objects, a piston or piston assembly with improved lubrication performance includes the following configuration.

In one aspect, the present invention provides a piston with improved lubrication performance. A steel piston body is configured by joining an upper block and a lower block with each other. A plurality of ring grooves is formed around an outer side surface of the steel piston body. A cooling gallery is formed to be sealed by joining the upper block and the lower block with each other. The cooling gallery includes an inlet port and an outlet port so that oil flows into or out of the cooling gallery. An oil hole is formed to fluidically communicate the cooling gallery with a first oil groove disposed in the outer side surface of the steel piston body. When the steel piston body moves upward, oil drawn into the cooling gallery is drawn into the first oil groove and thus supplied to a skirt of the piston body.

In a preferred embodiment, the piston may further include a second oil groove disposed in a lower portion of the skirt of the steel piston body.

In another preferred embodiment, when the steel piston body moves downwards, oil that is in the second oil groove may be supplied to an upper portion of the steel piston body by inertia of the oil.

In still another preferred embodiment, the first oil groove may be disposed in an upper portion of the skirt of the piston body.

In yet another preferred embodiment, the outlet port disposed in the cooling gallery may comprise at least one or more outlet ports.

In one aspect, the present invention provides a piston assembly with improved lubrication performance. A steel piston body is configured by joining an upper block and a lower block with each other. A connecting rod is coupled with the lower block. The steel piston body includes a plurality of ring grooves formed around an outer side surface of the steel piston body; a cooling gallery formed to be sealed by joining the upper block and the lower block with each other, the cooling gallery including an inlet port and an outlet port so that oil flows into or out of the cooling gallery; and an oil hole formed to fluidically communicate the cooling gallery with a first oil groove disposed in the outer side surface of the steel piston body. Wherein the first oil groove is disposed such that oil drawn into the cooling gallery is scattered, by movement of the steel piston body, to a space in which the steel piston body and a cylinder liner make contact with each other. Oil discharged from the outlet port of the cooling gallery is drawn to a position at which a small end of the connecting rod and the steel piston body come into contact with each other.

In a preferred embodiment, the piston assembly may further include: a second oil groove disposed in a lower portion of a skirt of the steel piston body.

In another preferred embodiment, when the steel piston body moves downwards, oil that is in the second oil groove may be supplied to an upper portion of the steel piston body by inertia of the oil.

In still another preferred embodiment, the first oil groove may be disposed in an upper portion of the skirt of the piston body.

In yet another preferred embodiment, the outlet port disposed in the cooling gallery may comprise at least one or more outlet ports.

In still yet another preferred embodiment, the outlet port may be disposed on a center axis of the piston body.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a sectional view illustrating a steel piston including a cooling gallery according to a conventional art;

FIG. 2 is a side view illustrating a piston assembly including a first oil groove and a second oil groove according to an embodiment of the present invention;

FIG. 3 is a side view illustrating the piston assembly including oil holes through which oil is supplied into a piston body according to the embodiment of the present invention;

FIG. 4 is a side sectional view illustrating the piston assembly including the first oil groove and the second oil groove according to the embodiment of the present invention;

FIG. 5 illustrates an operation of scattering oil onto a sidewall of the piston body through the first oil groove according to the embodiment of the present invention;

FIG. 6 illustrates an operation of scattering oil onto the sidewall of the piston body through the second oil groove according to the embodiment of the present invention;

FIG. 7 illustrates an inlet port and an outlet port which fluidically communicate with a cooling gallery according to the embodiment of the present invention; and

FIG. 8 is a side sectional view illustrating the configuration of a connecting rod coupled with the piston body according to the embodiment of the present invention.

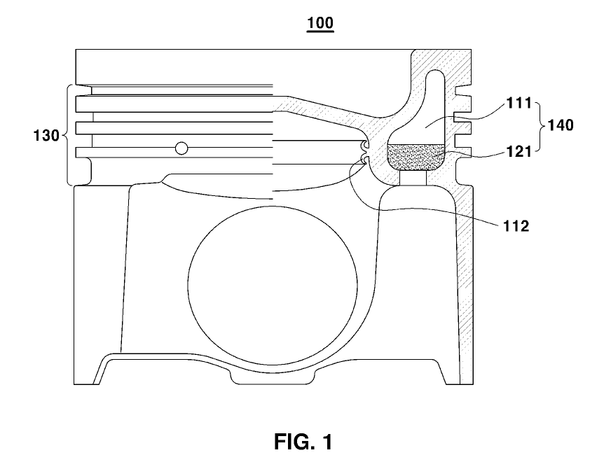

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF ILLUSTRATIVE EMBODIMENTS

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Further, in the following detailed description, names of constituents, which are in the same relationship, are divided into “the first”, “the second”, etc., but the present invention is not necessarily limited to the order in the following description.

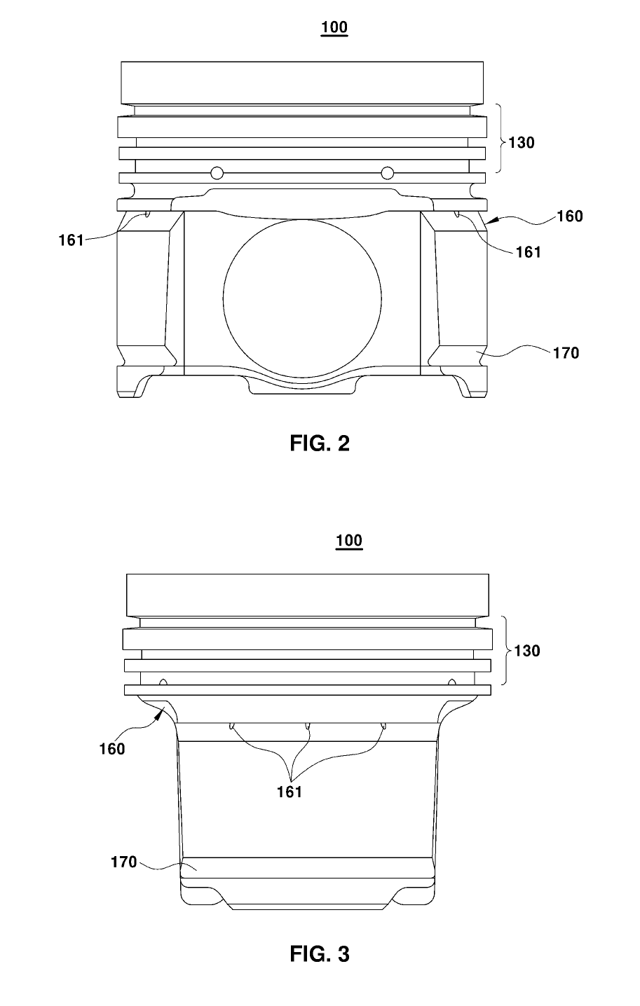

FIG. 2 illustrates a piston assembly with improved lubrication performance according to an embodiment of the present invention.

As shown in the drawing, the present invention relates to a steel piston for a diesel engine and includes a piston body 100 which is configured by joining an upper block 110 and a lower block 120 with each other. The upper block 110 and the lower block 120 respectively include concave spaces 111 and 121 which face each other. When the piston body 100 is formed, the concave spaces 111 and 121 are aligned with each other such that they are sealed in the piston body 100 so as to form a cooling gallery 140.

The cooling gallery 140 is disposed in the piston body 100 and is formed to have a hollow sealed structure. More preferably, the cooling gallery 140 may comprise a sealed-type oil gallery or an open type gallery of which the bottom is open.

Furthermore, the piston body 100 includes an inlet port 141 into which engine oil is supplied, and an outlet port 142 through which oil used to cool an upper part of the piston body 100 is discharged to the outside. That is, to guide the flow of cooling oil from a supply source (not shown) such as an oil jet while the diesel engine is operated, the inlet port 141 and the outlet port 142 are open toward the bottom of the piston body 100 and directly fluidically communicate with the oil gallery.

In the case where the bottom of the piston body 100 is formed by casting (for example, injection casting), the oil inlet port 141 may be integrally formed in the bottom of the piston body 100 as a cast-in member rather than being formed by a separate machining process after the casting. The bottom of the piston body 100 may include at least one oil outlet port 142 or inlet port 141. To discharge oil from the cooling gallery 140 into a crank chamber of the engine while the engine is operated, the oil outlet port 142 is open toward the bottom of the piston body 100 such that the oil outlet port 142 fluidically communicates with the cooling gallery 140. The at least one oil outlet port 142 may be a member which is formed in the bottom of the piston body 100 by casting.

More preferably, the outlet port 142 of the present invention may be formed at a position closest to a connecting rod 200 and be configured to scatter oil onto a portion on which the connecting rod 200 operates while making contact with the cooling gallery 140.

The present invention includes a first oil groove 160 which is formed to fluidically communicate with the cooling gallery 140. The first oil groove 160 may be formed below a plurality of piston ring grooves 130 which encloses an outer side surface of the piston body 100. More preferably, the first oil groove 160 may be disposed over a piston skirt 150.

The first oil groove 160 may include at least one oil hole which is fluidically coupled with the cooling gallery 140 such that oil is drawn from the cooling gallery 140 into the first oil groove 160. The first oil groove 160 may be configured such that when the piston body 100 moves upwards, oil in the cooling gallery 140 is drawn onto the first oil groove 160 or oil is drawn onto the first oil groove 160 by its own weight.

A second oil groove 170 may be formed in a lower portion of the skirt 150 of the piston body 100. The second oil groove 170 is formed such that when the piston body 100 moves downwards, oil that is in the second oil groove 170 is scattered onto the outer side surface of the piston body 100 by the inertia.

That is, the first oil groove 160 includes the at least one oil hole 161 which is fluidically coupled with the interior of the cooling gallery 140, so that when the piston body 100 moves upwards, oil that is in the cooling gallery 140 is drawn into the first oil groove 160.

In addition, oil that is sprayed onto the sidewall of the piston body 100 through the first oil groove 160 is drawn into the second oil groove 170 that is disposed in the lower end of the skirt 150 of the piston body 100. When the piston body 100 moves downwards, oil that remains in the second oil groove 170 is scattered onto the outer surface of the piston body 100 by the inertia of the oil.

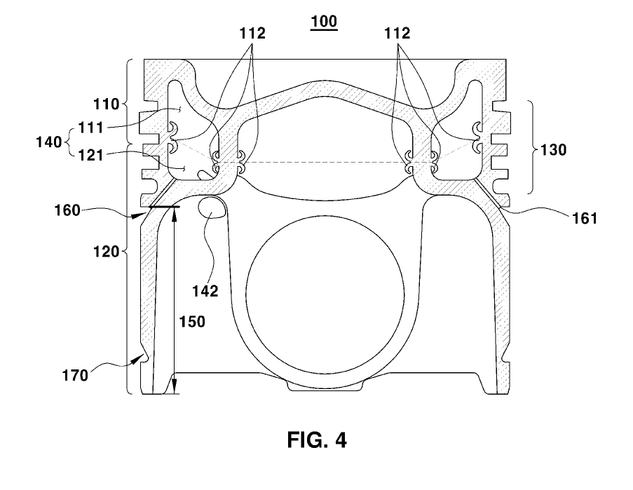

FIG. 3 shows a side view of the piston assembly with improved lubrication performance according to the present invention.

Referring to FIG. 3, a plurality of oil holes 161 are formed in the first oil groove 160 and configured to fluidically communicate with the interior of the cooling gallery 140. More preferably, the plurality of oil holes 161 may be spaced apart from each other at regular intervals in the first oil groove 160.

Furthermore, as shown in the drawing, the first oil groove 160 may be disposed in an upper portion of the skirt 150 which is formed under the plurality of ring grooves 130, and the second oil groove 170 may be disposed in the lower portion of the skirt 150.

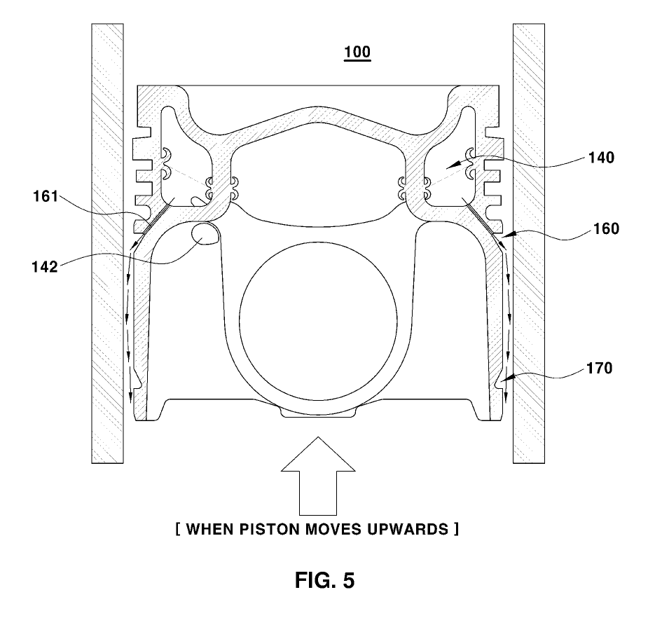

FIG. 4 shows a side sectional view of the piston assembly with improved lubrication performance according to the present invention.

The steel piston of the present invention may be configured such that the upper block 110 and the lower block 120 are joined with each other. The upper block 110 and the lower block 120 may include curved tailings 112. The curved tailings 112 may be typically formed by a friction welding process. In the case of the piston body 100 of the present invention, the curved tailings 112 may be formed by friction welding between the upper block 110 and the lower block 120.

The upper block 110 and the lower block 120 respectively include the concave spaces 111 and 121 at positions facing each other. The parts of the upper and lower blocks 110 and 120 that define concave spaces 111 and 121 make close contact with each other and thus form the sealed cooling gallery 140.

The oil holes 161 are formed such that they fluidically communicate with the interior of the piston cooling gallery 140 and are coupled with the first oil groove 160 which is disposed in the upper portion of the skirt 150. The oil holes 161 that extend from the cooling gallery 140 to the first oil groove 160 are inclined at a predetermined angle based on a vertical axis direction of the piston body 100. The first oil groove 160 communicating with the oil holes 161 may be formed to extend at the same angle as the angle at which the oil holes 161 are formed. More preferably, the first oil groove 160 may be formed at an angle less than the angle at which the oil holes 161 are inclined based on the vertical axis direction of the piston body 100.

The second oil groove 170 is formed in the lower portion of the skirt 150 of the piston body 100 with a predetermined angle relative to the vertical axis direction. The second oil groove 170 may be inclined such that the depth thereof toward the center of the piston body 100 is increased from the upper end of the piston body 100 to the lower end thereof. More preferably, the second oil groove 170 may be configured such that the angle of the second oil groove 170 relative to the vertical axis direction is symmetrical (at an angle of 180°) with that of the first oil groove 160.

Each of the first and second oil grooves 160 and 170 may include a depressed portion such that depending on a required amount of lubricant for the piston body 100, an appropriate amount of oil can be received in the oil groove. Depending on the environment of use of the piston, the angle of each of the first and second oil grooves 160 and 170 relative to the vertical axis direction and the amount of oil that can be received in each oil groove may be changed.

FIG. 5 illustrates the flow of oil in the first oil groove 160 when the piston of the piston assembly with improved lubrication performance according to the present invention moves upwards.

When the piston body 100 moves upwards, oil is drawn into the cooling gallery 140 to cool the upper portion of the piston body 100. For this, the piston assembly is configured such that when the piston body 100 moves upwards, oil in the cooling gallery 140 is discharged into the first oil groove 160 through the oil holes 161. The oil discharged into the first oil groove 160 is scattered onto the outer surface of the piston body 100 along the inclined surface formed in the first oil groove 160. More preferably, the piston assembly may include an inclined part such that oil scattered from the first oil groove 160 is scattered toward the lower portion of the skirt 150 when the piston moves upwards.

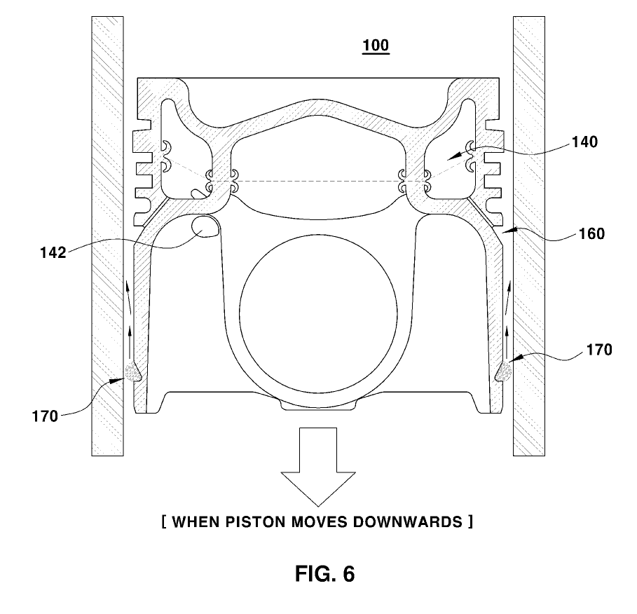

FIG. 6 illustrates the flow of oil in the second oil groove 170 when the piston of the piston assembly with improved lubrication performance according to the present invention moves downwards.

As shown in FIG. 5, when the piston body 100 moves upwards, oil in the cooling gallery 140 is moved along the oil holes 161 and then scattered from the first oil groove 160 toward the lower portion of the skirt 150. The scattered oil is drawn along the piston body 100 into the second oil groove 170 which is disposed in the lower portion of the skirt 150.

Thereafter, when the piston body 100 moves downwards, oil that is kept in the second oil groove 170 is scattered onto the surface of the piston body 100. That is, the piston assembly is configured such that when the piston body 100 moves downwards, oil that is in the second oil groove 170 is scattered into the space between the surface of the piston body 100 and the wall of the cylinder.

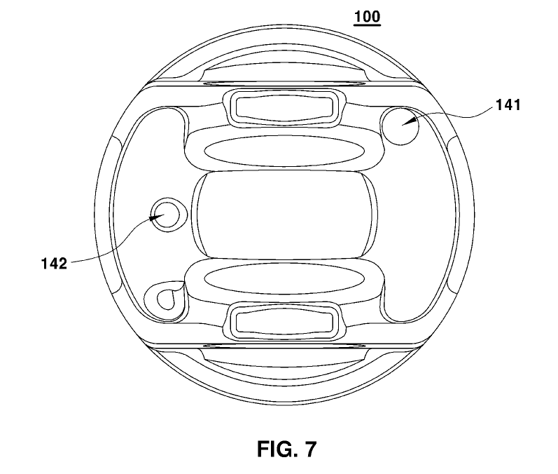

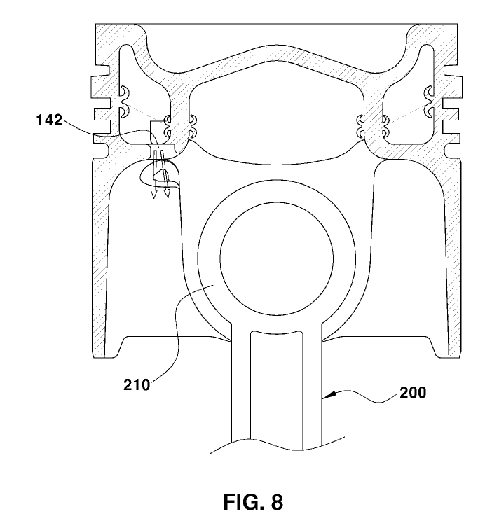

FIG. 7 illustrates the lower end of the piston assembly with improved lubrication performance according to the present invention and, in detail, shows the oil inlet port 141 and the outlet port 142 that communicate with the interior of the cooling gallery 140.

Oil is drawn from a main gallery or an oil gallery into the cooling gallery 140 that is sealed by the upper and lower parts of the piston. This is to cool heat generated from the piston body 100. Moreover, the sealed-type cooling gallery 140 is configured to include at least one oil inlet port 141 and at least one outlet port 142.

In the case of the piston assembly with improved lubrication performance according to the present invention, the outlet port 142 is disposed on the center axis of the piston so that oil can be discharged onto a small end 210 of the connecting rod that is coupled with the lower end of the piston body 100.

More preferably, the outlet port 142 is configured such that the cooling gallery 140 and the small end 210 of the connecting rod are fluidically coupled to each other so that oil in the cooling gallery 140 can be directly discharged into the space in which the small end 210 of the connecting rod and the lower end of the piston body 100 make contact with each other and friction therebetween is thus generated.

FIG. 8 illustrates a sectional view of the piston assembly with improved lubrication performance according to the present invention.

As shown in the drawing, oil discharged from the cooling gallery 140 is drawn, through the outlet port 142, onto the point at which the piston body 100 and the small end 210 of the connecting rod make contact with each other. The drawn oil provides lubrication between the piston body 100 and the connecting rod 200, thus reducing friction generated at the above-mentioned point.

That is, the cooling gallery 140 contains therein oil to be discharged through the outlet port 142 after cooling the upper part of the piston. Given this, the outlet port 142 is configured at a position adjacent to the small end 210 of the connecting rod. Thus, oil that has cooled the upper part of the piston body 100 is drawn through the outlet port 142 to the coupling point at which the small end 210 of the connecting rod and the piston body 100 are coupled to each other. More preferably, the outlet port 142 may be formed such that it is disposed at a position at which the center axis of the piston meets an axis perpendicular to a pin shaft coupled with the piston body 100.

As is apparent from the above description, a piston assembly with improved lubrication performance according to the present invention has the following effects.

The present invention uses oil drawn into a cooling gallery disposed in a piston body so as to provide an additional lubrication function for an outer surface of the piston body during the operation of the piston body, thus providing the effect of improving the operation performance of the piston.

Furthermore, the present invention is configured such that oil discharged from the cooling gallery is provided to space between a small end of a connecting rod configured to make it possible for the piston body to be operated and the piston body coupled with the connecting rod. Therefore, the present invention provides enhanced lubrication performance, thus improving the efficiency of the operation of the piston.

Moreover, the present invention can enhance the lubrication performance of the piston and the piston assembly, thus enhancing the drive efficiency of a vehicle.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A piston, comprising:
a steel piston body including an upper block and a lower block that are joined together;
a plurality of ring grooves formed around an outer side surface of the steel piston body;
a cooling gallery sealed between the upper block and the lower block, the cooling gallery including an inlet port and an outlet port so that oil can flow into or out of the cooling gallery; and
an oil hole formed to fluidically communicate the cooling gallery with a first oil groove disposed in the outer side surface of the steel piston body, wherein the piston is configured so that when the steel piston body moves upwards, oil drawn into the cooling gallery is drawn into the first oil groove and thus supplied to a skirt of the steel piston body.

2. The piston of claim 1, further comprising a second oil groove disposed in a lower portion of the skirt of the steel piston body.

3. The piston of claim 2, wherein the piston is configured so that when the steel piston body moves downwards, oil that is in the second oil groove is supplied to an upper portion of the steel piston body by inertia of the oil.

4. The piston of claim 1, wherein the first oil groove is disposed in an upper portion of the skirt of the steel piston body.

5. The piston of claim 1, wherein the first oil groove is disposed in an upper portion of the skirt of the steel piston body, the piston further comprising a second oil groove disposed in a lower portion of the skirt of the steel piston body.

6. The piston of claim 1, wherein the outlet port disposed in the cooling gallery is one of a plurality of outlet ports disposed in the cooling gallery.

7. The piston of claim 1, wherein the outlet port is disposed on a center axis of the steel piston body.

8. A piston assembly, comprising:
a steel piston body configured by joining an upper block and a lower block with each other; and
a connecting rod coupled with the lower block;
wherein the steel piston body comprises:
a plurality of ring grooves formed around an outer side surface of the steel piston body;
a cooling gallery sealed by the upper block and the lower block, the cooling gallery including an inlet port and an outlet port so that oil can flow into or out of the cooling gallery; and
an oil hole formed to fluidically communicate the cooling gallery with a first oil groove disposed in the outer side surface of the steel piston body;
wherein the first oil groove is disposed such that oil drawn into the cooling gallery is scattered, by movement of the steel piston body, to a space in which the steel piston body and a cylinder liner make contact with each other; and
wherein the piston assembly is configured so that oil discharged from the outlet port of the cooling gallery is drawn to a position at which a small end of the connecting rod and the steel piston body come into contact with each other.

9. The piston assembly of claim 8, further comprising a second oil groove disposed in a lower portion of a skirt of the steel piston body.

10. The piston assembly of claim 9, wherein the piston assembly is configured so that when the steel piston body moves downwards, oil that is in the second oil groove is supplied to an upper portion of the steel piston body by inertia of the oil.

11. The piston assembly of claim 8, wherein the first oil groove is disposed in an upper portion of a skirt of the steel piston body.

12. The piston assembly of claim 8, wherein the outlet port disposed in the cooling gallery is one of a plurality of outlet ports disposed in the cooling gallery.

13. The piston assembly of claim 8, wherein the outlet port is disposed on a center axis of the steel piston body.

14. A piston, comprising:
a piston body;
a plurality of ring grooves formed around an outer side surface of the piston body;
a cooling gallery within the piston body, the cooling gallery including an inlet port and a plurality of output ports so that oil can flow into or out of the cooling gallery; and
an oil hole formed to fluidically communicate the cooling gallery with a first oil groove disposed in an upper portion of a skirt of the piston body and a second oil groove disposed in a lower portion of the skirt of the piston body;
wherein the piston is configured so that when the piston body moves upwards, oil drawn into the cooling gallery is drawn into the first oil groove and thus supplied to a skirt of the piston body; and
wherein the piston is configured so that when the piston body moves downwards, oil that is in the second oil groove is supplied to an upper portion of the piston body by inertia of the oil.

15. The piston of claim 14, wherein the piston body comprises a steel piston body.

16. The piston of claim 14, wherein the piston body is configured by joining an upper block and a lower block with each other.
